(19) United States
(12) Patent Application Publication
(10) Pub. No.: US 2023/0264990 A1
(43) Pub. Date: Aug. 24, 2023

(54) Portable Electrodialysis Device With Flow Electrode

(71) Applicant: John J. Gresens, Fernandina, FL (US)

(72) Inventor: John J. Gresens, Fernandina, FL (US)

(21) Appl. No.: 18/112,294

(22) Filed: Feb. 21, 2023

Related U.S. Application Data
(60) Provisional application No. 63/312,729, filed on Feb. 22, 2022.
(60) Provisional application No. 63/312,732, filed on Feb. 22, 2022.

(51) Int. Cl. C02F 1/469; C02F 1/46

(52) U.S. Cl. CPC C02F 1/4693; C02F 1/4604; C02F 2201/46165; C02F 2201/4618; C02F 2103/08

(57) ABSTRACT

A disclosed portable replenishable scalable electrodialysis device includes conductive members extending the cell length, with a first conductive member connected to a negative polarity current and a second conductive member connected to a positive polarity current source. Each cell includes four membranes, with a first membrane positioned adjacent a first conductive member, a second membrane positioned adjacent a second conductive member, etc. Each cell has five channels, with a first channel positioned between the first membrane and the first conductive member, the second channel positioned between the second membrane and the second conductive member, etc. The device is connected to sources of salt water, diluent water, and water with conductive material, where the water with the conductive material is flowed through a first channel and a second channel, and the salt water is flowed through a third and fourth channel and the diluent is flowed through said fifth channel.

### CROSS-REFERENCE TO RELATED APPLICATIONS

The present application claims priority to U.S. Provisional Patent Application No. 63/312,729, filed Feb. 22, 2022, entitled “PORTABLE WATER PURIFICATION DEVICE,” and further claims priority to U.S. Provisional Pat. App. No. 63/312,732, filed Feb. 22, 2022, entitled “PORTABLE WATER PURIFICATION DEVICE WITH FLOW ELECTRODE,” all of which are by the same inventor as the present application, and all of which are hereby incorporated by reference herein in their entirety.

### FIELD OF THE DISCLOSURE

The disclosure relates generally to water desalination. More specifically, the disclosure relates to devices and processes for water desalination through an electrodialysis device comprising replenishable components along with the removal of other undesirable contaminants that impede the acquisition of potable water.

### BACKGROUND

Water purification has been a concern around the world for decades. Recent phenomena such as global warming and the heightened awareness to the impact of long outstanding environmental contaminants on water resources have maintained the relevance of processes and devices useful in purifying water.

Over 70% of the earth's surface is covered with water. Of this volume, over 97.5% of this water contains some concentration of salt. This leaves a mere 2.5% of the earth's water as fresh water with then only 1% of the earth's water being fresh and easily accessible (US Geological Survey). Global warming and the resulting rising tides have given renewed importance to the sustainability of fresh water resources. The level of salinity in water varies all over the world from the brines found in river basins that meet the oceans of the world to the salt water found in the deep oceans covering large expanses of the earth.

Beyond salinity, there is the problem of contamination of water resources with biological materials and, of late, other materials such as heavy metals like lead, cadmium, and various other chemistries conventionally used in the manufacture of everything from consumer electronics to food stuff packaging. Indeed, some of these chemistries are so ubiquitous in modern life that we are only now coming to realize the problems these chemistries are causing. The combination of environmental contaminants along with the need for potable water can make the provision of fresh potable water a daunting task at times.

The variance in salinity may range from 0 pounds of salt per gallon of water to saturation with almost 3 pounds of salt per gallon of water. Desalination has previously been addressed using different techniques. The ultimate goal of desalination of water with varying levels of salt has had differing levels of success. Desalination facilities have traditionally been large industrial plants sponsored by state and national governments addressing needs for potable drinking water or irrigating arid land which is desirable for agricultural applications. Smaller devices have also been developed. However, even these smaller devices generally have a price point that is beyond the pedestrian retail market. Further, any device used for these applications often needs to be as complicated as the variety of environments into which the device is applied. This is a difficult goal to meet for a device that is possibly constrained by size and price.

Another concern that arises from time to time is the discovery of environmental contaminants affecting water resources bound for local communities. Examples of such situations include the leaching of heavy metals into estuaries, aquafers, or reservoirs among other water supply sources. Contaminants may also be found inside the actual sight of consumption. For example, lead pipe and solders were commonly used in many residential and commercial domiciles and buildings for the last century. Indeed, many houses built in the last 100 years still have a lead feed pipe providing the residence with city water.

Efforts at purifying water have varied greatly. Simple mechanical devices have been developed such as that disclosed in U.S. Pat. No. 4,800,018 which shows a filter device which purifies water through gravity flow. Both of U.S. Pat. No. 6,344,146 and U.S. Pat. No. 8,216,462 combine the structure of reservoir and filter with that of a pump to facilitate water flow through the filter.

Electrical devices include those disclosed in U.S. Pat. No. 6,296,756. The disclosed device uses electrolysis to increase oxygen content in the water to be treated. Another device is disclosed in U.S. Pat. No. 8,816,300 which teaches the use of ultra violet and LED energy to purify water.

Any number of devices have been developed for the purification of water. For example, U.S. Pat. No. 8,043,499 discloses a water purification system using reverse osmosis. The system is designed to work from photovoltaic and wind energy and is portable. Electrodialysis devices disclosed include those of U.S. Pat. Nos. 6,402,917 and 6,537,436.

Technology such as electrodialysis and capacitive deionization has been known for some time as a method of purifying water. See, for example, U.S. Pat. No. 7,662,267 which discloses yet another illustration of an electrodialysis device. U.S. Pat. No. 11,261,109 discloses past desalination devices ultimately claiming a method of desalination by capacitive deionization using a single cell and a flow electrode.

While these developments in the technology of water purification are noteworthy, concerns over economy, size, performance and portability among other considerations persist. As a result, there is a need for further development and solutions in the field of water purification, especially water desalination.

### BRIEF DESCRIPTION OF THE FIGURES

FIG. 1A is a perspective view of one embodiment of the desalination device showing the device contained within an outer housing.

FIG. 1B is a flow diagram of the process used by the device including the reservoirs for feeding the salt water/brine into the device and the reservoir for feeding the flow electrode, respectively, into the device as well as the reservoirs for receiving the desalinated water, salt/brine, and fluid electrode. Recycle loops for water and the flow electrode are also depicted.

FIG. 1C is a perspective view of the internal workings of the desalination device shown in FIG. 1A.

FIG. 2 is an exploded view of one embodiment of the desalination cells in the device depicted in FIG. 1C showing the respective fluid and electrical interconnections between cells.

FIG. 3A is a side plan view of one embodiment of an individual cell used in the desalination device.

FIG. 3B is a cut away view of the individual desalination cell shown in FIG. 3A and used in the desalination device.

FIG. 3C is a cutaway view of the cell shown in FIG. 3A interconnected to a cell of identical design depicting fluid and electrical interconnections.

FIGS. 4A-4C are various views of one embodiment of an end cap useful in the desalination device.

FIG. 5A is a perspective view of a further embodiment of an individual cell used in the desalination device.

FIG. 5B is a side plan view of one embodiment of an in-line coupling insert useful in the transmission of the fluid electrode, salt water, and desalinated water through the desalination device.

FIG. 5C is an exploded cutaway side view of one embodiment of a cell useful in the desalination device illustrating the end cap assembly including the in-line coupling of FIG. 4B.

FIG. 6A is a cutaway side plan view of one embodiment of the bottom portion of the device as shown in FIG. 1A showing the seats for the individual cells as well as underlying space for the fluid and electrical interconnection of the individual cells as depicted in FIG. 2.

FIG. 6B is a cutaway side view of one embodiment of the device of the top portion as shown in FIG. 1A showing the seats for the individual cells as well the upper space for the fluid and electrical interconnections of the individual cells as depicted in FIG. 2.

FIG. 7 is a top plan view of one embodiment of the interior of the bottom portion of the desalination device of FIG. 6A. The interior of the top portion of the desalination device is the mirror image of FIG. 7.

FIG. 8 is a side plan view depicting insertion of one embodiment of the cells into the base of the desalination device.

FIG. 9A is a partial perspective view of one half of a cell interior showing a conductive member at the center base of the interior surface of the cell half.

FIG. 9B is a partial top plan view of one embodiment of a membrane support useful in the desalination device.

FIG. 9C is a side plan view of the membrane support shown in FIG. 9B.

FIG. 9D is a partial perspective view of one half of a cell interior useful in the desalination device showing the conductive member at the center base of the interior of the cell half and placement of the membrane support within the cell half.

FIG. 9E is a cutaway sectional side view of one embodiment shown in FIG. 9D.

FIG. 10A is a partial perspective view of one half of a cell interior of the desalination device showing the conductive member at the center base of the interior of the cell half along with placement of the membrane support within the cell half and placement of the membrane within the membrane support.

FIG. 10B is a side plan view of a partial cell assembly depicted in FIG. 10A.

FIG. 11A is a partial perspective view of one embodiment of a membrane clip useful in the desalination device.

FIG. 11B is a side plan view of the membrane clip shown in FIG. 11A.

FIG. 12A is a partial perspective view of one half of cell interior useful in the desalination device showing the conductive member at the center base of the interior of the cell half along with placement of the membrane support within the cell half, further placement of the membrane within the membrane support and placement of a further membrane positioned within the membrane clips at the midpoint of the cell.

FIG. 12B is a side plan view of a partial cell assembly depicted in FIG. 12A.

FIG. 13A is a side plan view of one embodiment of the membrane of FIG. 12A positioned within the membrane clips at the midpoint of the cell.

FIG. 13B is a partial side plan view of a further embodiment of the membrane affixed to the membrane clips and positioned within midpoint rails at the midpoint of the cell.

FIG. 13C is a side plan view of a cell useful in the desalination device shown in FIG. 4A in accordance with one embodiment.

FIG. 14 is a perspective view of a further embodiment of a cell (as seen for example in FIG. 4A) useful in the desalination device depicting a clam shell orientation fully opened with a first side fixed but pivoting around an axis which traverses the length of the cell and a second side which may be opened and closed so as to be water tight.

### DETAILED DESCRIPTION

Levels of salinity in water vary across the globe. Across differing bodies of water, “salt water” has differing concentrations of salt depending on season, environmental conditions such as temperature, humidity, and geography. Weather conditions such as drought or monsoon, among other factors may also affect the concentration of salt in water. As a result, there does not tend to be a one size shoe fits all feet solution to desalination. At the same time, the disclosed device may be used in any number of environments and adapted to varying levels of salinity by using varying electrical parameters, water feed rate including the dwell time within the device for the water to be treated as well as any number of secondary filters used to address contaminants other than salt.

Generally, fresh potable water has less than 0.5 ppt of salt while brackish water is considered water with a salinity of about 0.5 to 17 ppt of salt. Seawater may have a salt concentration which ranges radically depending upon ambient conditions. Generally, seawater has a salt concentration ranging from 30 to 40 ppt, on average about 35 ppt. Brine is considered water with a salt concentration over about 50 ppt salt. Here again, the actual salt concentration in water may vary considerably from one body of water to the next given evaporation, freezing, and freshwater runoff among other factors affecting ocean bodies which span miles and project to depths of hundreds of feet.

The disclosed device is a portable replenishable scalable electrodialysis device. The device uses a plurality of desalinization cells to recover among other solutions, potable water from salt water. The cells generally have conductive elements and ion specific membranes over and through which the water to be recovered flows. The disclosed device is scalable in that prefilters may be added to the device to trap other contaminants such as heavy metals, suspended solids, and biological materials, among other contaminants found in water. Additional cells may also be added to the device if added efficacy in desalination is required. It is contemplated that the disclosed device uses a plurality, at least two, of desalination cells. The cells used in this device are also replenishable allowing for the removal and replacement of the cell membranes along with other component parts. The device uses a conductive flow electrode comprising water and conductive particles such as particulate graphite.

In one aspect, a disclosed portable replenishable scalable electrodialysis device includes a salt water inlet for receiving salt water; a fluid electrode inlet for receiving water that contains a conductive material; a diluent water inlet for receiving diluent water; and a plurality of electrodialysis cells. Each of the electrodialysis cells includes a first conductive member that extends a length of the electrodialysis cell, and is operatively coupled to a first current source having a negative polarity. A second conductive member also extends the length of the electrodialysis cell, and is operatively coupled to a second current source having a positive polarity. A first removable membrane is positioned adjacent the first conductive member, and is configured to have a first polarity. A second removable membrane is positioned adjacent the second conductive member, and is configured to have a second polarity opposite to the first polarity. A third removable membrane is positioned adjacent the first membrane, and is configured to have the second polarity opposite to the first polarity. A fourth removable membrane is positioned adjacent the second membrane, and is configured to have the first polarity. A first channel is positioned between the first membrane and the first conductive member, and is operatively coupled to the fluid electrode inlet such that water containing a conductive material can be flowed through the first channel. A second channel is positioned between the second membrane and the second conductive member, and is operatively coupled to the fluid electrode inlet such that the water containing the conductive material can be flowed through the second channel. A third channel is positioned adjacent the first membrane, and is operatively coupled to the salt water inlet such that salt water can be flowed through the third channel. A fourth channel is positioned adjacent the second membrane, and is operatively coupled to the salt water inlet such that salt water can be flowed through the fourth channel. A fifth channel is positioned between the third membrane and the fourth membrane, and is operatively coupled to the diluent water inlet such that diluent water can be flowed through the fifth channel.

As used herein “operative coupling” refers to direct or indirect connections in which one or more intervening parts, pieces, devices, etc. may be used to form a connection between two points. In the case of liquid flow operative coupling, examples of such intervening parts, pieces, devices, etc. may include, but are not limited to, pipes, tubing, hoses, valves, pumps, filters, fittings, regulators, restrictors, flow meters, connectors, etc. In the case of electrical operative coupling, examples of such intervening parts, pieces, devices, etc. may include, but are not limited to, circuit breakers, switches, transformers, relays, connections, plugs, receptacles, fuses, capacitors, diodes, transistors, etc.

In another aspect of a disclosed portable replenishable scalable electrodialysis device, the device includes a plurality of electrodialysis cells, with each of the cells having a first end, a second end, a cell wall, and removable end caps covering the first and second ends. Each of the cells has first and second conductive members extending the length of each of the electrodialysis cells. The first conductive member is electrically connected to a first current source with a negative polarity and the second conductive member is electrically connected to a second current source with a positive polarity. Each of the electrodialysis cells has a first, second, third, and fourth membrane. The first membrane is positioned adjacent the first conductive member, the second membrane is positioned adjacent the second conductive member, the third membrane is positioned adjacent the first membrane, and the fourth membrane is positioned adjacent the second membrane. The first and fourth membranes have a first polarity and the second and third membranes have a second polarity which is the opposite of the first polarity of the first and fourth membranes. The first, second, third and fourth membranes are removable from each of the electrodialysis cells. Each of the cells also have five channels. The first channel is positioned between the first membrane and the first conductive member. The second channel is positioned between the second membrane and the second conductive member. The third channel is positioned adjacent the first membrane. The fourth channel is positioned adjacent the second membrane, and the fifth channel is positioned between the third membrane and the fourth membrane. The electrodialysis device is connected to a source of water to be desalinated, a source of diluent water and a source of water that contains a conductive material. The water containing the conductive material (fluid electrode) is flowed through the first channel and the second channel. The water to be desalinated (salt water) is flowed through the third and fourth channel, and diluent water is flowed through the fifth channel.

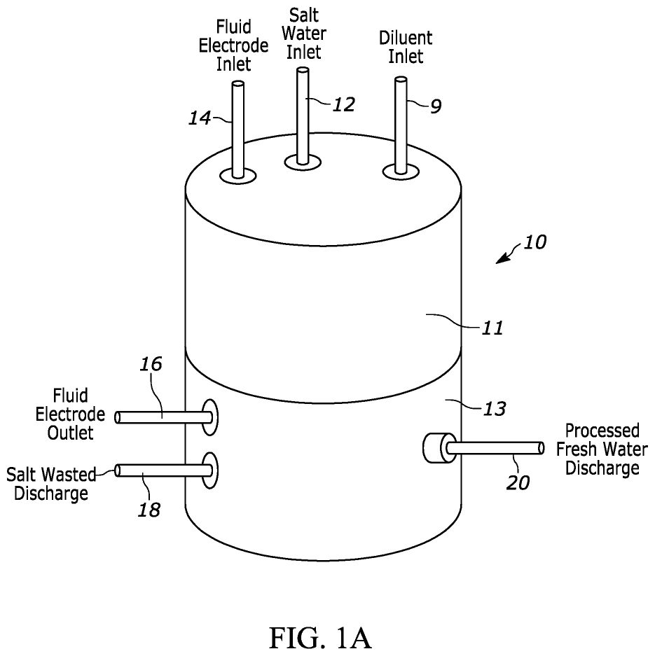

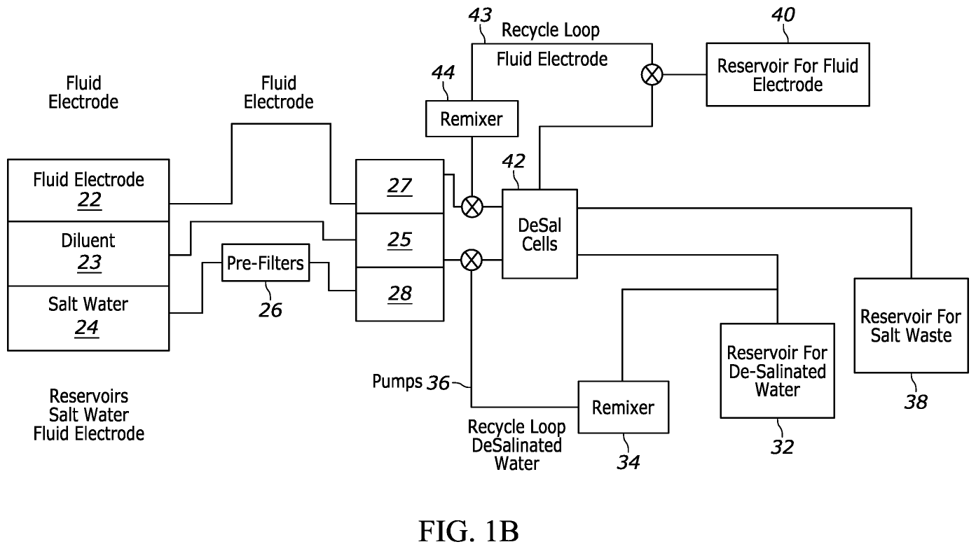

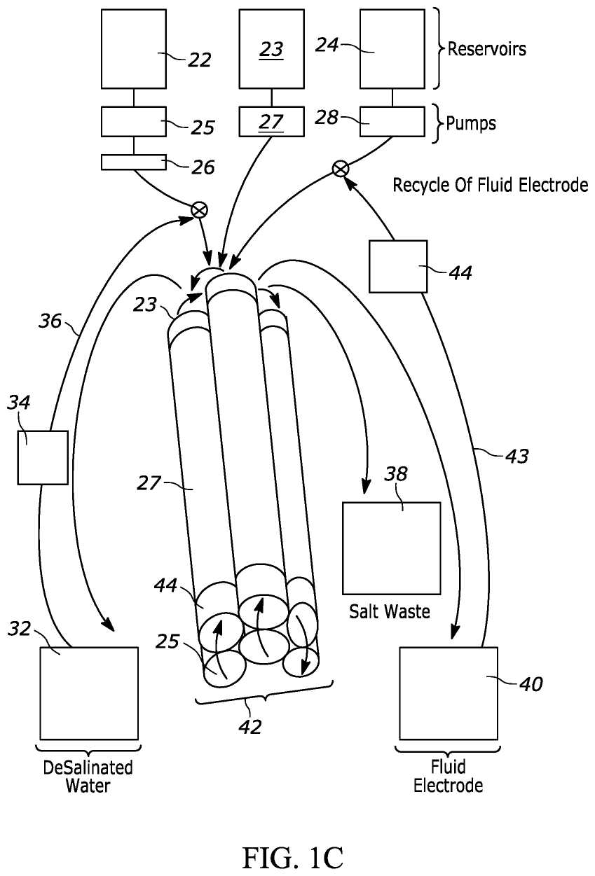

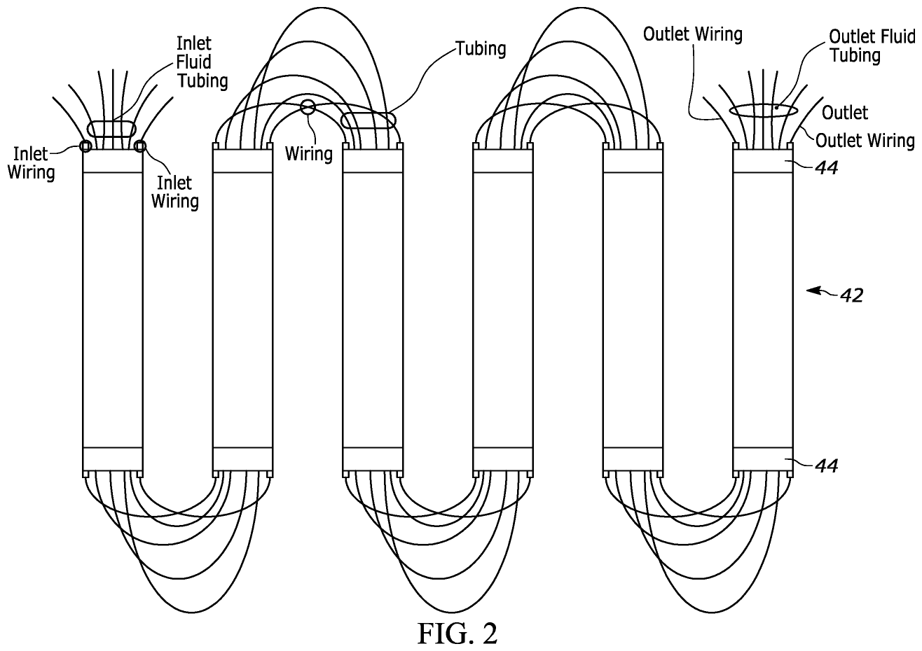

Turning to the Figures wherein like parts are designated with like numerals throughout several views, there is disclosed an electrodialysis device 10 and process for desalinating water containing some concentration of salt in FIGS. 1A-1C and 2. As the device is scalable, other water borne contaminants may also be addressed as well.

The disclosed device is a portable replenishable scalable electrodialysis device which may be contained within an outer casing 10 FIG. 1A. The device, FIG. 1C, comprises a plurality of deionization cells 42. As shown the outer casing 10 has a top portion 11 and a bottom portion 13. The outer casing has several inlets for diluent 9, salt water 12, fluid electrode 14. The outer casing also has outlets for the fluid electrode 16, salt waste discharge 18, and for discharge of the processed fresh water 20.

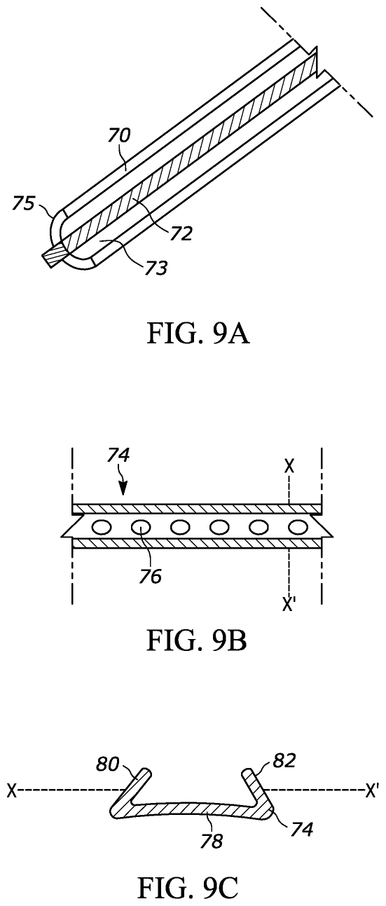

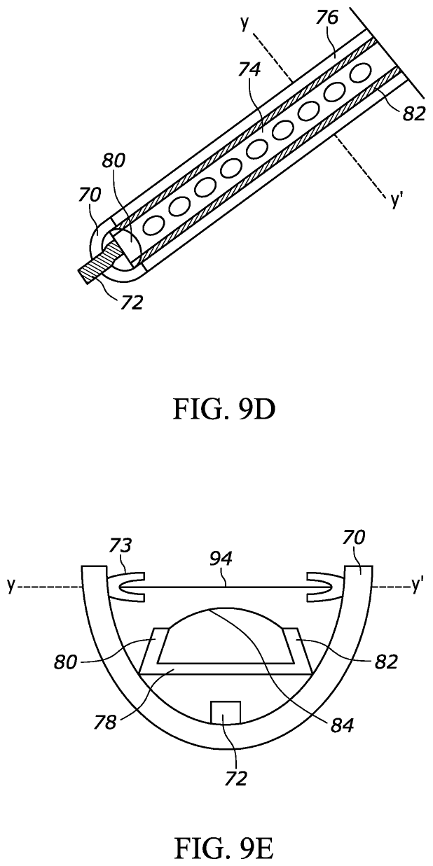

Each of the cells has a first end 23 and a second end 25, FIG. 2, with each of the cells comprising a cell wall 27, the cell wall having an interior surface 73 (see FIG. 9A) and an exterior surface 75 (also FIG. 9A), and comprising removable end caps 44 covering the cell first end 23 and second end 25.

Turning to FIG. 1B, a schematic depiction of the process used in the device is illustrated. Water comprising some concentration of salt (feedstock to be desalinated) is contained within a reservoir 24. An adjacent reservoir 22 contains the flow electrode. The flow electrode reservoir 22 may be stirred as the flow electrode may be water comprising a conductive substance such as graphite. A diluent may be contained within reservoir 23. Given the disclosed desalination process the diluent may be water as well, recycled from the device.

The water/salt feedstock may be prefiltered 26 to reduce or eliminate the concentration of larger contaminants within the feedstock. The feedstock and the flow electrode may then be drawn through respective pumps 27 and 28. As depicted, there may be one pump 28 for the feedstock and another pump 27 for the flow electrode. The diluent is drawn by pump 25.

From the pumps 25, 27 and 28, the diluent, water/salt feedstock, and flow electrode may enter the desalination cells 42. Processing within the desalination cell 42 is explained subsequently. Once processed, the desalinated water may be decanted off into a reservoir 32. Alternatively, the now once processed water may be recycled 36 back through the desalination cells 42. Recycling the water to be processed through the desalination cells 42 repeatedly is within the scope of the various disclosed embodiments. Once the feedstock water has been sufficiently desalinated it may be decanted off to the reservoir 32.

Salt waste resulting from the desalination device is decanted off into a reservoir 38 for further use or disposal. The flow electrode may either be decanted off into a reservoir 40 or recycled through a loop 43 back to the desalination cells 42. As part of the recycle loop 43 a remixer 44 may be used to ensure that the conductive material remains suspended within the flow electrode solution.

An even more detailed view of the inner workings of one embodiment of the disclosed device may be seen in FIG. 1C. As with the device illustrated in FIG. 1B, reservoirs 22, 23 and 24 hold the feedstock water to be desalinated, diluent, and the flow electrode, respectively. These three solutions are drawn through pumps 25, 27, and 28. The water/salt feedstock may first, optionally, be drawn through any number of prefilters 26 depending on the character and quality of the feedstock water to be desalinated. All three solutions were then pumped into the desalination cells 42.

As shown in FIG. 2, the individual desalination cells 42 are in fluid and electrical communication in series with each other. Once the water/salt feedstock has been desalinated, this desalinated water may be decanted off into a fresh water reservoir 32. Alternatively, if further processing is necessary the water/salt feedstock may be further processed by recycling the feedstock back through the desalination cells 42, FIG. 1B. Optionally, as the feedstock (water containing salt) is recycled 36, the water/salt feedstock may be remixed 34 before reintroduction back into the desalination cells 42.

In turn, the highly concentrated salt containing water may be decanted off on a continuing basis into another reservoir 38. The flow electrode may be decanted off into a further reservoir 40 or, alternatively, recycled 43 back through an optional remixer 44 into the desalination cells 42, FIG. 1B.

The connection between the individual cells is illustrated in FIG. 2. As can be seen, the individual desalination cells 42 are interconnected in series. These interconnections facilitate electrical and fluid flow from one desalination cell to the next. This embodiment (FIG. 2) shows six desalination cells 42. However, depending on the character and quality of the feedstock, greater or fewer desalination cells 42 may be appropriate. It is contemplated that a plurality (at least two) of desalination cells 42 are used in the device.

Another means of calculating the necessary number of desalination cells is to determine the necessary processing length (inches or centimeters) of cells 42 necessary to fully desalinate the water containing salt feedstock. In order to facilitate portability as well as the ability of the operator to replenish the individual cells, the length of the individual cells may be limited to under 30 inches.

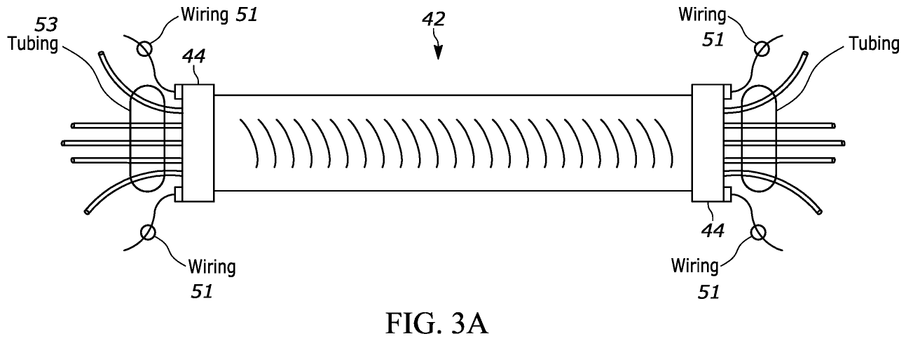

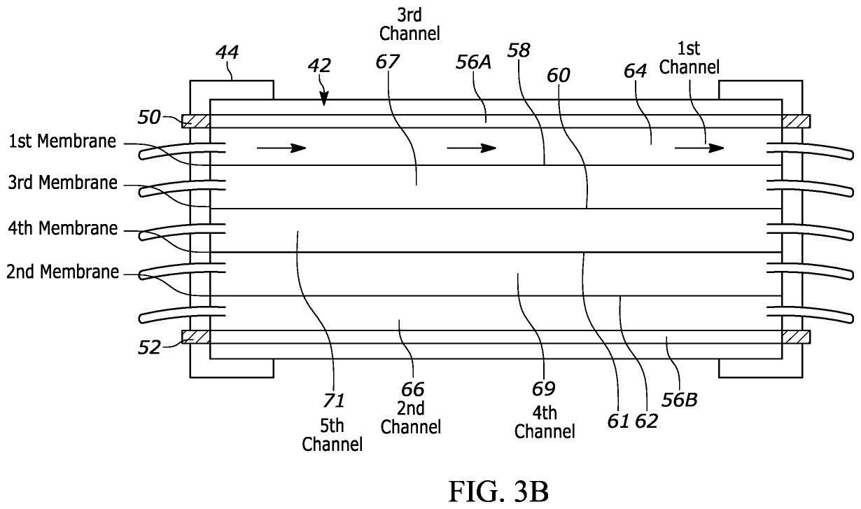

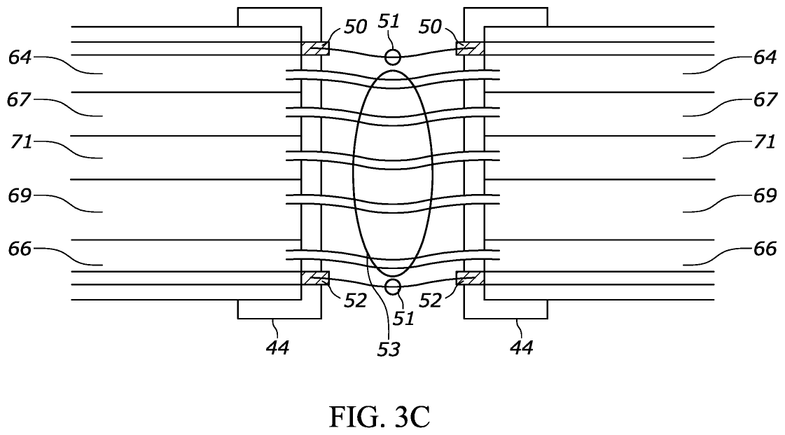

FIGS. 3A-3C illustrate one embodiments of an individual desalination cell in accordance with the embodiments. Among other embodiments, the desalination cell may take the design shown in FIG. 3A with interconnectivity as shown in FIG. 2, that is interconnecting wiring 51 and interconnecting tubing 53. This embodiment of the desalination cell is distinguished by the use of tubing to provide feedstock, diluent and the conductive electrode which is inserted through the end caps 44 and held in place either by friction, clip on or through the use of other means such as adhesives or tape.

Turning to FIG. 3B, each of the cells has first and second conductive members 56A and 56B, respectively, extending the length of each of the desalinization cells 42. The first conductive member 56A is electrically connected to a first current source through contact 50, the first current source having either a negative or positive polarity. The second conductive member 56B is electrically connected to a second current source through contact 52 and has the opposite polarity of the first current source.

Each of the desalinization cells has first, second, third and fourth membranes, FIG. 3B. The first membrane 58 is positioned adjacent the first conductive member 56A. The second membrane 62 is positioned adjacent the second conductive member 56B. The third membrane 60 is positioned adjacent the first membrane 58. The fourth membrane 61 is positioned adjacent the second membrane 62. The first, second, third and fourth membranes are removable and replaceable from each of the desalinization cells 42.

The two membranes adjacent the conductive member charged with a positive polarity are anionic selective membranes and the two membranes adjacent the conductive member charged with a negative polarity are cationic selective membranes. Membranes 61 and 62 are paired with one polarity and membranes 58 and 60 are paired with opposite polarity, FIG. 3B.

Each of the cells 42 has first, second, third, fourth, and fifth channels. The first channel 64 lies between the first membrane 58 and the first conductive member 56A. The second channel 66 lies between the second membrane 62 and the second conductive member 56B. The third channel 67 lies between the first membrane 58 and the second membrane 60. The fourth channel 69 lies between the second membrane 62 and the fourth membrane 61. The fifth channel 71 lies between the second membrane 60 and the fourth membrane 61, FIG. 3B.

The disclosed device is replenishable and connected to a source of water to be desalinated 24, a source of diluent 23 and a source of flow electrode 22, FIG. 1C. The flow electrode may be, for example, water comprising a conductive material. The water having the conductive material is flowed through the first channel 64 and returned through the second channel 66, FIG. 3B. The flow electrode may be recovered in this manner given the opposite polarities of the first and second electrode. The flow electrode may also be purged from the device and replenished with fresh flow electrode.

The water to be desalinated is flowed through the fifth channel 71 with the diluent flowing through the third channel 67 and fourth channel 69. The device may have three reservoirs, the first reservoir for containing the desalinated water 32, the second reservoir 38 for containing the liquid salt waste and the third reservoir 40 for containing the flow electrode.

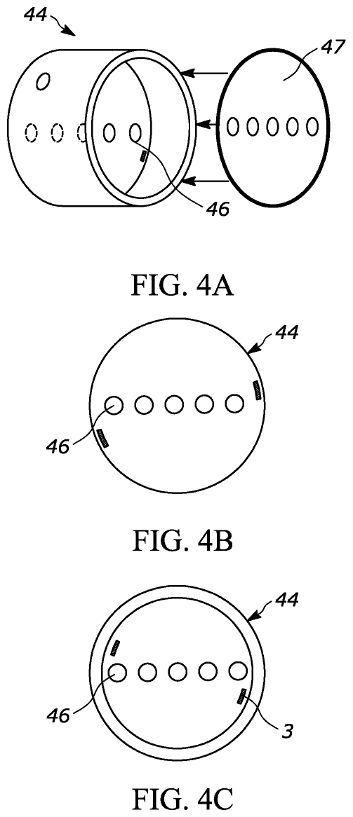

Returning to FIG. 3B, enough tubing is inserted through the end caps 44 to allow insertion into the various channels within the cell 42. The individual channels are sealed against the unintended leaking of flow electrode, feed stock, or diluent across the five channels without proceeding first through the respective four membranes. Additional sealing means 47 (FIG. 4A) to prevent leakage may be used such as foam, putty or rubber placed on the interior surfaces of the end cap 44. The end caps 44 have holes 46 for the insertion of tubing intended to receive the feedstock, diluent, and liquid electrode, FIG. 4A-4C. The additional sealing means 47 prevents the cross contamination of fluid from one channel to another.

As can be seen in FIG. 3B, each desalination cell 42 includes four membranes, that is, a first 58, second 62, third 60 and fourth 61 membrane. For water desalination the membranes are either cationic selective or anionic selective and they alternate depending on the polarity of the electrode to which they are adjacent. Electrodes 56A and 56B carry either a positive or negative charge, respectively. If electrode 56A is charged positively, electrode 56B is charged negatively. Generally, the first membrane 58 and the fourth membrane 61 comprise a composition for exclusion of ions of one polarity and the second membrane 62 and third membrane comprise a composition for the exclusion of ions of the opposite polarity. Generally, the selection of polarity for the membranes is not consequential as long as both polarities are used in each cell 42 and the ion exchange membranes alternate in ion selectivity. The electrode 56A and 56B are energized by an electrical power source affixed to contacts 50 and 52 located at either end of each cell 42, FIG. 3B.

Understanding that opposite polarities attract and that sodium chloride dissolves in water, the appropriate configuration can be set for each cell thereby drawing sodium ions in one direction and chloride ions in the opposite direction.

In use, any number of alternative arrangements are possible. Using a plurality (two or more) of desalination cells 42, the water containing the salt (feedstock) may be processed by cells arranged in series, FIGS. 2 and 3C. Using a larger desalination cell 42 and/or longer feedstock dwell times within the desalination cell 42 fewer desalination cells may be used. It has been found that at least two desalination cells 42 are preferable in the device. With the use of a plurality of cells 42, the cells may be interconnected as shown in FIG. 3C. As can be seen, wiring 51 between contacts 50 and 52 electrically interconnect the current collectors of the two desalinization cells shown in FIG. 3C. In turn, tubing interconnects the respective channels 64, 67, 71, 69, and 66. Here again, tubing 53 may be held in place by adhesive, putty or friction fitting. Wiring may be held in place by any conventional means such as solder or adhesive.

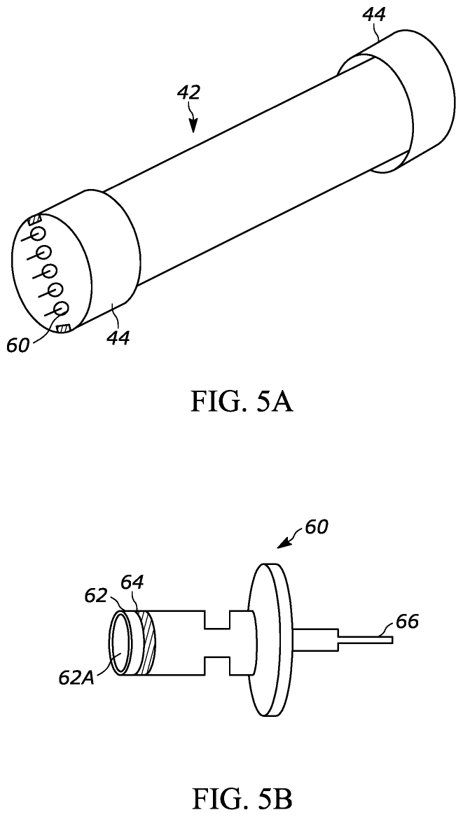

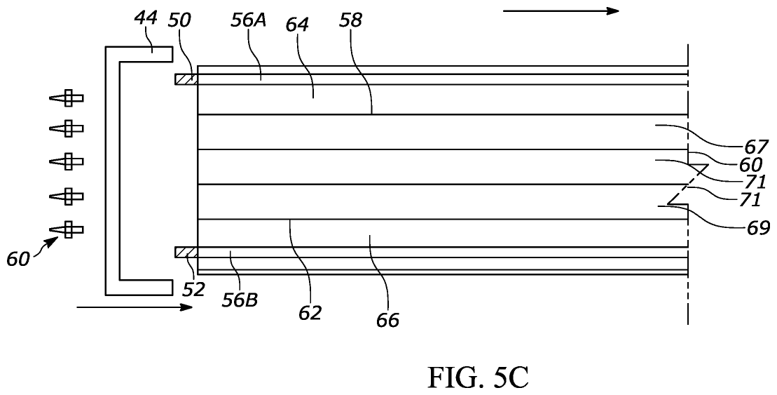

A further embodiment of the desalination cell 42 is illustrated in FIGS. 5A-5C. In this embodiment, the desalination cell 42 may be used as a “plug-in” element in the device. In this embodiment of the portable replenishable capacitive deionization device, the desalination cells 42 have an assembly and components much the same as the desalination cell illustrated in FIGS. 3A-3C.

In this embodiment, the end caps 44 have holes 46. In the holes 46, joining elements 60 are inserted, FIGS. 5A and 5B. Joining element end 62 is inserted into the end cap holes 46, FIG. 4A, so that it is inside the desalination cell 42 and held in place by a rubber gasket 64, FIGS. 5A and 5B. Joining element end 66 protrudes 60 from the end cap 44, FIG. 5A. If a further extension of the joining element is needed to extend into the cell a tube may be inserted into opening 62A, FIG. 5B.

As can be seen in FIG. 5C, this embodiment of the desalination cell has four membranes (58, 60, 71, 62), five channels (64, 67, 71, 69, 66), two electrodes (56A and 56B) fed by contacts (50 and 52), as well as inlets and outlets. Instead of external tubing as seen in FIG. 2, the electrical and fluid interconnections between the desalination cells are contained within the outer casing 10 as explained herein while consistent with FIG. 2.

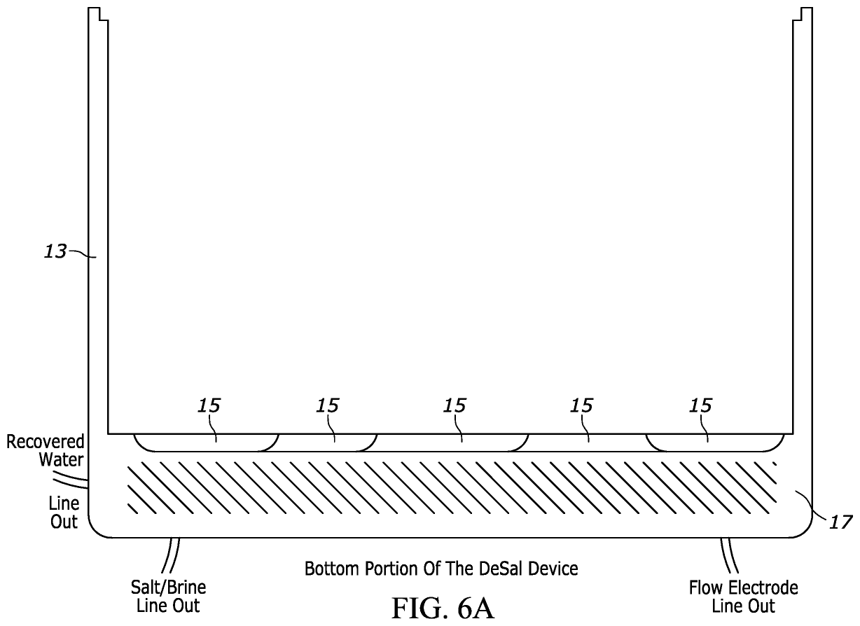

Referring back to FIG. 1, the outer casing 10 may be a two-piece structure having a top portion 11 and a bottom portion 13. Both the top and bottom portions have complementary seats 15 for receiving the desalinization cells 42 as shown in FIGS. 5A-5C. As can be seen in FIGS. 6A and 6B, the top 11 and bottom 13 portions of the outer casing 10 may fit together in a tongue and groove manner. The patterning of the seats 15 within the casing 10 depends on the number of desalination cells 42, (FIG. 5A) used in the disclosed device of the. Each of the seats has a pattern of grommet lined holes 9 set to accept the exterior end 66 of the joining element 60 and electrical contacts 8 to facilitate electrical interconnection between the cells.

In the exemplary embodiment illustrated in FIG. 7, six desalination cells 42 are contemplated. As shown in FIG. 7, the patterning of the seats 15 is for the bottom portion 13 of the outer casing of the device. The seat pattern for the top portion 11 of the outer casing 10 is the mirror image of the seat pattern for the bottom portion 13 of the outer casing 10.

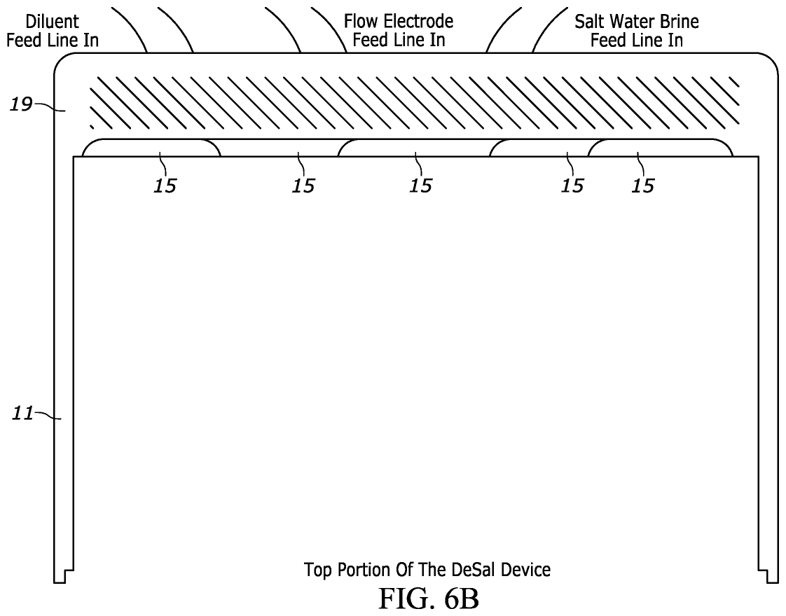

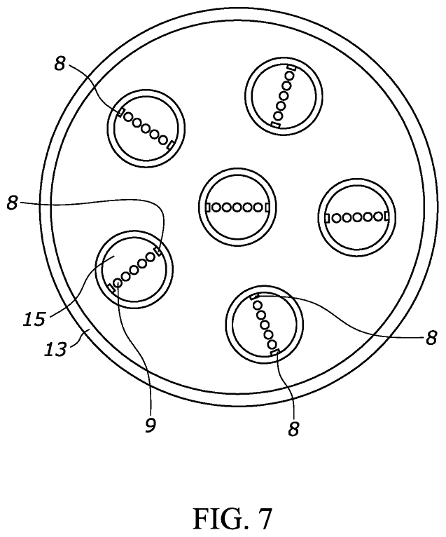

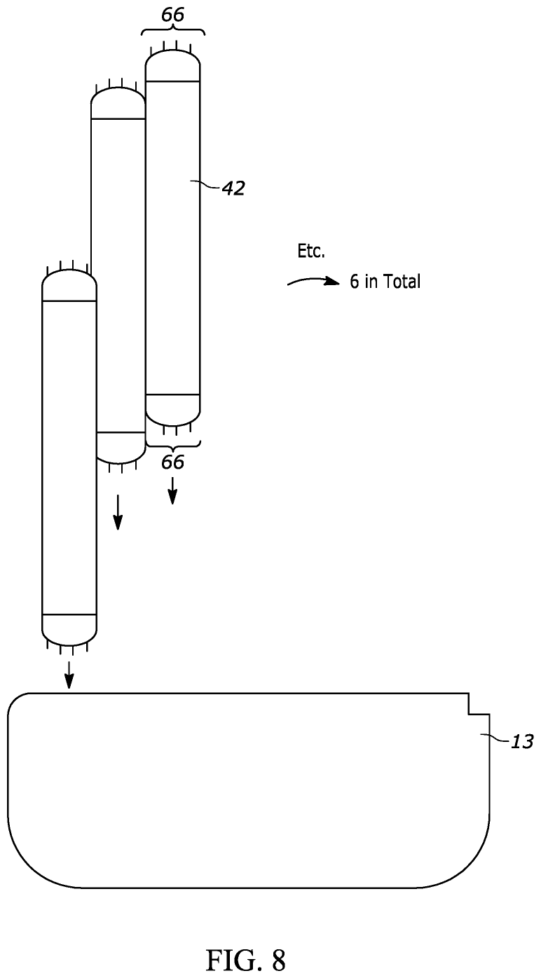

In this embodiment, the lower interconnections (both wiring and fluid) between the desalination cells 42 are housed in the bottom portion 13 of the outer casing in the volume 17 beneath the seats 15, FIG. 6A. The upper portion 11 of the outer casing 10 houses the upper fluid and electrical interconnections between desalination cells 42, FIG. 6B, in the volume 15 above seats. Although not shown in FIGS. 6A and 6B, the patterning of fluid and electrical interconnections between the individual seats 15 in this embodiment of the device is consistent with the interconnections between desalination cells illustrated in FIG. 2. The desalination cells 42 are then plugged into the bottom portion 13 of the outer casing, (FIG. 8), and the top portion 11 is fit over the desalination cells 42 in a complimentary manner and affixed to the bottom portion 13 of the outer casing 10. Receipt of the cell into the bottom and top portion of the casing may be completed by simply inserting the joining element ends 66 into the seat(s) 15 in the base of the outer casing bottom and top portion, FIG. 8. Joining element ends fit into openings 9, FIG. 7 which may be lined with rubber grommets to provide a water tight seal between the individual cells and the underlying tubing which provides interconnectivity between the cells.

As the device is modular it may be built out through any number of cells 42 as well as other devices given the need for added filtering, pumping capacity, etc. The device may be provided with increased recovery capacity by adding further cells. A remixer may be used between two desalination cells. This allows for the desalination cells to be used in series to further recover and purify the water to be recovered.

The water to be purified by the device may be delivered through any number of means including gravity flow, electrical pump, etc. The longer the resident time for the feedstock (water to be recovered) in the cells of the device, the more efficient the recovery process.

A mechanical or electromechanical pump is preferred as allowing the stepped or adjustable means of flowing water to the device given varying levels of salinity. Any number of pumping devices may be used to pump the various fluids through the device. One family of pumps that have been found useful include those made by Stenner of Jacksonville Fla. Of particular use are the peristaltic metering pumps such as ECON FX and VX.

The power source for the device may take the form of alternating current, direct current or a combination of the two. Preferably, electrical power is used to charge the static electrodes of the device and any further electrical appliance used with the device such as a pump. The source of electricity may comprise any available resource including solar energy, wind energy, as well as conventional industrial or residential sources of electricity alternating and/or direct current. For example, photovoltaic energy, generator derived energy, nuclear energy, coal based energy, natural gas based energy, etc. may be used.

The cell may be comprised of any material which does not interfere with the intended recovery of water. Plastic polymers, ceramics including glass, and nonconductive metal alloys among other materials are all useful. In cross section the cells may be circular (cylindrical), square, oblong, rectangular, or any other shape which facilitates operation of the device. One source for cell materials is Harrington Industrial Plastics of Jacksonville, Fla. In embodiments formed as cylindrical tubes, the cells may have a contiguous outer surface.

This design of the device facilitates use in domestic/residential environments as well as field use in any number of institutional or governmental applications. The length of the cells may range from about 12 inches to about 20 inches, at most 30 inches. The cross section of each cell may be square, rectangular, or circular among other shapes. The width of the cell may range from 0.5 inch to 5 inches. The cells may be comprised of ceramics such as glass, polymeric plastics such as PVC, or nonconductive metals which will not interfere with the recovery process. End caps may also be obtained commercially through any number of sources such as Harrington Industrial Plastics of Jacksonville Fla.

In the production of a system of cells the individual cells may be joined through adhesives or mechanical fixtures, among other means. If the intention is to build a system which is modular, the cells may be affixed to one another in a manner which allows the addition of further cells (or devices) to the original device. Further the device can be configured to accept membranes which may be replaced if worn over time or if the system is applied to a different environment of use.

Each cell has end caps at either end, each having holes for the introduction of a feed line and two lines for recovered water and saline, respectively. Conductive member 56A, 56B are placed on the interior of either side of the cell adjacent and running the length of the cell. Contacts 50, 52 for the conductive members 56A, 56B are placed adjacent the end caps. The contacts allow for electrical connection of the conductive members 56A, 56B to a power source and interconnection of the cells from cell to cell or individually.

Suitable electrode (56A and 56B, FIG. 3B) materials include any conductive material such as copper, and conductive graphite, among other materials. Commercially available materials include conductive graphite available from HP Material Solutions of California and conductive copper tape available made by Tapes Master and available through Amazon or directly from Tapes Master at tapesmaster.com.

The current collectors may be charged by a DC power source on either side of the cell. Here again, the current collectors may be charged in series or individually. As the purity and volume of recovered water may vary, use of a step or adjustable or steppable DC power source is preferred. One power source which is has been found useful is a Daedalon AC/DC Power Supply available from Science First in Jacksonville Fla., (www.sciencefirst.com).

The relative thickness of the electrodes ranges from about 0.5 mm to about 1 cm. The width of the electrodes generally ranges from about 0.1 mm to about 2 cm. This allows for the necessary dimensions to provide for the necessary voltage and current density to draw the respective contaminant ions through the respective ion selective membranes and out of the fluid stream to be recovered.

Water purification using this technology is based on solubility of salt ions (anions and cations) in water. Unlike poles attract and like poles repel, thus the ions migrate toward the poles of opposite charge. Suitable membranes allow the selective passage of either anions or cations towards the pole of opposite charge. Suitable membranes may depend on the ionic species to be selected for separation from the fluid to be recovered. In water desalination, generally useful membranes may be classified as cationic or anionic.

Membranes may comprise any number of materials. Polymeric materials such as thermoplastic or thermosetting polymers are useful in forming selective membranes in accordance with the embodiments. Thermoplastic polymers useful in making membranes in accordance with the embodiments include vinyl polymers such as polyethylene, polypropylene, as well as polyesters, polyamides, polyimides, polyamide-imides, polyethers, block polyamides-polyethers, block polyester polyethers, polycarbonates, polysulfones, polybisimidazoles, polybisoxazoles, polybisthiazoles, and polyphenyl polymers. Other thermoplastic polymers which may be useful as membrane material include nylons, polyacetals, poly acetals, polyurethanes, polyphenyl-aniline sulfides, polypropylenes, and poly ether ether ketones among others.

Generally thermoplastic polymers and copolymers comprising monomers including ethylene, propylene, styrene, acrylonitrile, butadiene, isoprene, acrylic acid, methacrylic acid, methylacrylate, methylmethacrylate, vinyl acetate, hydroxy methacrylate, hydroxyl ethyl acrylate as well as other known vinyl monomers.

Membranes useful in various embodiments may also be fabricated from thermosetting polymers. Useful thermosetting polymer systems in accordance with some embodiments include epoxies, polyurethanes, polyesters, acrylics, bismaleimides such as the reaction product of bismaleimide and methyl dianiline. Other thermosetting polymers that may be used in fabricating membranes useful in the various embodiments include silicones, phenolics, polyamides, polysulfides, curable polyesters, maleate resins that are the reaction product of polyols and maleic anhydride. Maleic anhydride may also be reacted with various acids such as fumaric acid and isophthalic acid among others.

Suitable cationic membranes may comprise monomers of styrene, aniline, vinyl chloride, styrene, butadiene, propylene, and ethylene, among other monomers. Representative polymers which may be used as a cationic exchange membrane include polystyrene and polyanaline blends, heterogeneous polyvinylchloride/styrene-butadiene-rubber blends, and monovalent selective membranes made of blends of sulfonated poly (ether sulfone) with sulfonated poly (ether ether ketone. Ceramic cation exchange membranes may also be used in accordance with some embodiments such as those synthesized by impregnating ceramic supports with zirconium phosphate or phosphor tungstic acid-based membranes deposited on graphite supports.

Useful anionic exchange membranes may include, for example, poly(vinyltrimethoxysilane-co-2-(dimethylamine)ethylmethacrlylate) copolymer, membranes composed of 4-vinylbenzyl chloride, styrene, and ethyl methacrylate, cross-linked polystyrene, acrylonitrile/butadiene/styrene with activated carbon and silver fillers, and aliphatic-hydrocarbon based anion exchange membranes prepared from glycidyl methacrylate and divinylbenzene, among others.

Commercially available anionic and cationic ion selective membranes which are useful in the device include those available from the Fuji Film Membrane Technology Group such as the Type 10 and Type 12 anionic and cationic ion exchange membrane. Also preferable are those membranes available from Resin-Tech Inc. such as anionic AMB-SS and cationic CMB-SS both presented in single sheets.

In one embodiment, (FIGS. 9A through 9E), fabrication of the desalination cells comprises a number of steps. To one section of a cell wall 73, a conductive element 72 is affixed using mechanical means or adhesive, FIG. 9A. Membrane support 74 is next affixed to interior surface 73 of the cell wall 70 adjacent the conductive member 72, FIG. 9D and 9E. The membrane support 74 may have holes 76 to facilitate passage of ions to the conductive element 72. The support 74 is positioned adjacent to, and over, the conductive element 72.

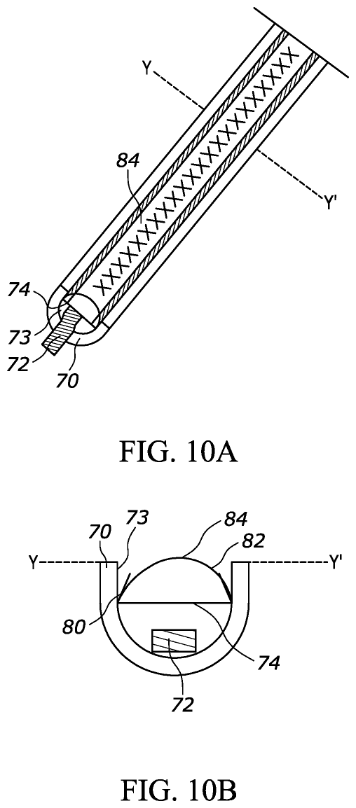

The membrane support 74 may take any number of configurations, FIG. 9C. One useful embodiment of the membrane support 74 is shown in FIGS. 9B and 9C. As is seen in cross section, FIG. 9C, the membrane support 74 has a base 78 and two side walls, 80 and 82, affixed to the support base 78. The side walls are directed inwardly towards each other across the surface of the support base 78. The membrane support 74 may be affixed to the inner surface 73 of the cell wall 70 through any mechanical or adhesive means, FIG. 9C. Membrane 84 may be inserted and held by the membrane support sidewalls 80 and 82 adjacent the conductive element 72, FIGS. 10A and 10B.

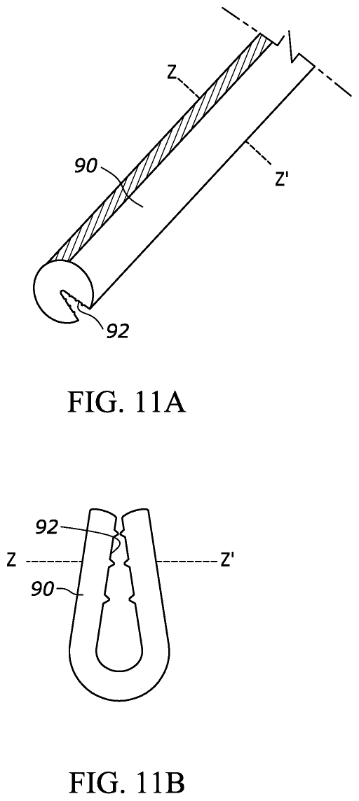

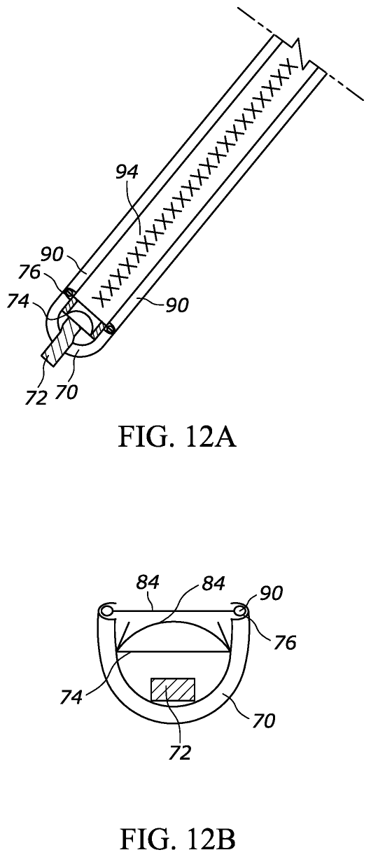

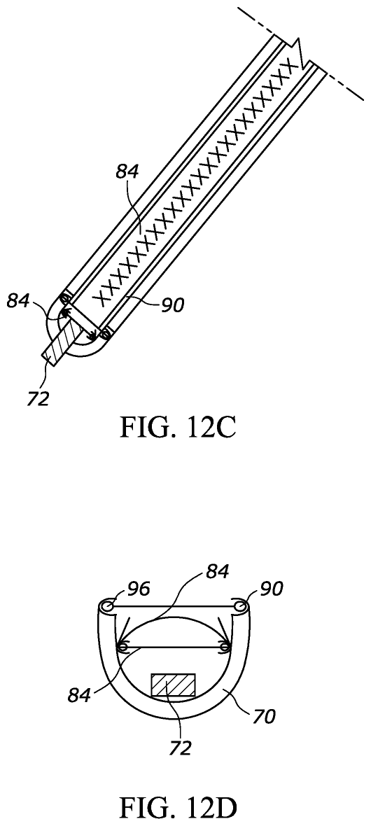

An alternative means of affixing the membranes within the desalination cell is seen in FIGS. 11A and 11B. The clip 90 has a smaller dimension, narrows, towards its opening and comprises interior teeth 92. The design of the clip allows the expansion and contraction of the membrane as the membrane cycles through use. It is usual for ion exchange membranes to expand when wet and contract when drying. The teeth 92 in the clip 90 also facilitate removal of the membrane over the length of the desalination cell 42 while fixing the membrane in position across the width of the cell 42. The clips 90 may be attached to the joining surface 76 of the cell housing 70 (FIGS. 9D and 12A) using means such as adhesives, for example epoxies or polyurethanes. Membrane 94 may then be inserted into clips 90, FIG. 12A. Alternatively, the clips 90 may be affixed to the interior wall 73 of the cell, FIG. 9A.

To make the membranes 84 resistant to leakage, the membranes may be coated on their linear side edge 96, that edge running along the entire length of the cell on either side of the membrane so that fluid (e.g., water) will not leak around the edges of the membrane that are seated in the clips 90 in the sidewalls of the cell 42. It is within the scope of various embodiments that all of the membranes have a bead of rubber or cured polymer at the linear side edges 96. This design also allows the membranes to be replaced over time, to allow for different conditions of use or wear and tear of the membrane.

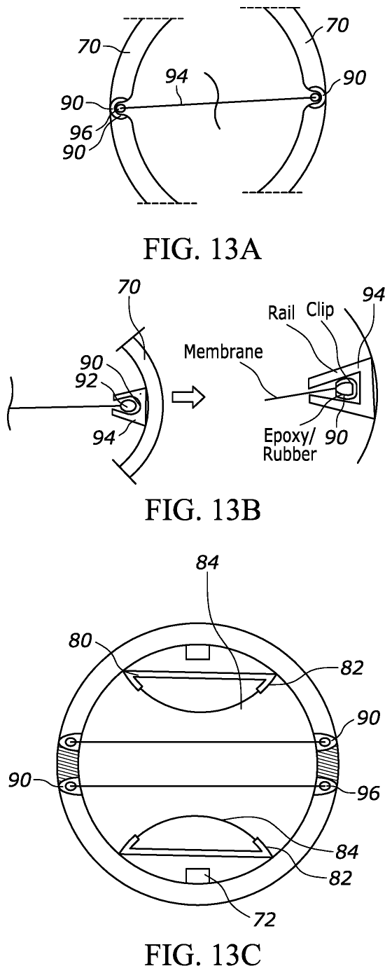

FIGS. 13A through 13C illustrate the containment of a membrane 94 to which the bead of rubber or cured polymer 96 has been applied to the side edge of the membrane within clips 90, FIG. 13A. The desalination cell 42 may also comprise rails 94 running the length of the desalination cell 42. The rails 94 facilitate the insertion and removal of the membrane 94 which may or may not also be fixed on either side by clip 90. A side cutaway view of the completed desalination cell 42 may be seen in FIG. 13C.

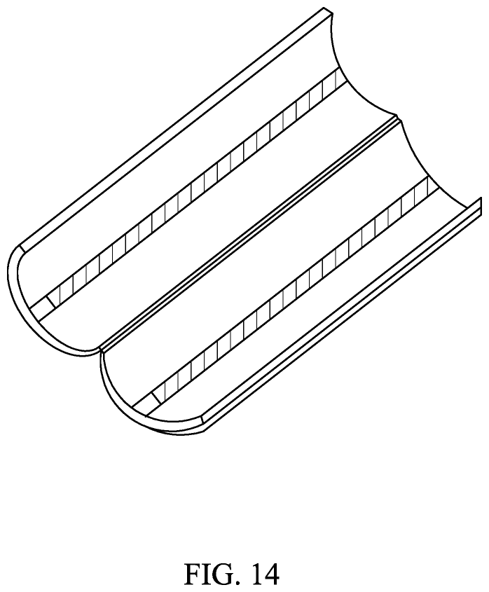

In order to facilitate replacement of component parts the desalination cell may be hinged on one side in a clam shell design, FIG. 14A. This design allows easy replacement of membranes as well as service of the desalination cell if the cell falls into disrepair.

If a higher level of water quality is required, the device may comprise a recycle loop, FIG. 1C. The loop is engaged through the use of any number of means such as stop cocks at the beginning and the end of the loop.

### WORKING EXAMPLES

The following examples illustrate certain attributes and properties of the disclosed device.

From a ten-foot length of clear PVC pipe (1.9 inches OD, schedule 40 Harrington Industrial Plastics, Jacksonville Fla.) six twelve-inch sections were cut. Each of the twelve-inch sections were then cut lengthwise in half over the twelve-inch length. Two ½ inch strips of conductive copper (Tapes Master Inc.) tape with adhesive on one side were then laid into each section at the edge of each of the twelve sections. The conductive tape was allowed to run past the twelve-inch length on both sides to enable connection from cell to cell as well as connection to a DC power source.

Ion selective membranes (anionic and cationic) were obtained from Resin Tech Inc. in single sheet stock. The respective anionic and cationic membranes were cut to size, the membrane support fashioned from edge trim obtained from Ace Hardware, Jacksonville Fla. The membrane supports were cut to 12-inch lengths corresponding to the length of the cells. Using a hole punch, openings were punched in the base of the membrane support. The width of the first membrane (cationic) was cut to extend from the base of the membrane support in an arcuate shape across the length of the support. The second half of each cell was prepared in the same manner except using an anion exchange membrane.

The third and fourth membranes were cut in the same manner as the first two membranes—although larger—and mounted to the sections of each cell half as the sections were assembled to form the six cells. In order to make the larger sections of membrane removable, the membrane was inserted into 1/16 inch butyrate U channel clear plastic moldings (708-Cl Outwater Plastics) that have been cut to the 12 inch length of the cell halves. The moldings were attached to the cell halves using hot glue (Gorilla Glue). End caps were fashioned using Harrington Industrial Plastics (Jacksonville Fla.) caps appropriately sized to fit the ends of each cell once the two half sections of the cell were combined to form each of the six cells. Five holes were drilled in each of the end caps to allow for the attachment of device inlet, outlet, and the interconnection of the cells allowing fluid flow from one cell to the next.

Tubing was connected to the end caps for each of the three holes to provide for an inlet and outlet as well as the interconnections between cells. Flexible polypropylene tubing was used for the inlet, outlet as well as interconnection between the cells. Water flow was facilitated using three Model ECON FX Pumps (85MPH5) made by Stenner of Jacksonville Fla. The flow rate ranged from 0.1 gpm to 15.1 gpm for the water needing purification and the flow rate for the anionic and cationic flushing fluids ranged from 0.1 gpm to 15.1 gpm.

From the reservoirs (flow electrode, water for recovery and diluent) these respective fluids passed to the pump. From the pump, the water to be recovered was flowed into the cells. Once through the cells the water is decanted off, recovered water in one vessel and concentrated saline in another. At the same time water was flowed through an immediately adjacent channel which through the electric attraction of the flow electrode will draw and concentrate saline ions into the channel to be flushed from the system.

From a further reservoir, the fluid electrode was dispensed. This fluid is a mixture of conductive carbon particles suspended in water. The fluid electrode was flowed between the copper film and the membrane in a continuous loop through the anionic and cationic sides of the cell through which they are connected. After coming through both sides of the cell the fluid electrode is subjected to a remixer. A 2500 ml Erlenmeyer flask was useful having an input for receiving the water-carbon particle mixture and an output allowing the fluid electrode to be pumped back into the cells. The addition of further volumes of fluid electrode is controlled by a stop cock.

As part of the recycle loop, a mixing vessel may be used to enhance the homogeneity of the water to be reclaimed. One system found useful is a vessel or flask with a double-hose barbs to allow the flow electrode in for mixing/remixing and out for introduction into the flow electrode channel. Mixing in the flask was undertaken using Intllab Magnetic Stirrer. The recovered water was tested for salinity using a refractometer.

Because concentration polarization becomes more important as the solution becomes more dilute, the solution velocity increases in the stacks processing the most dilute solution. The velocity of the solution may be controlled using the pump which is stoppable and can be adjusted to provide a slower or faster rate of fluid flow. Typically, large recovery systems have 6-10 cells in series to achieve the recovered water. This will depend on salinity, weather, and other environmental conditions. For applications requiring high purity water, the device may be run in series with the flow electrode, recovered water, and concentrated saline flowing from one device to the next. The fluid and electrical connections may be discrete to each set of cells or configured in series across the entire system.

Depletion of ions at the membrane surface means that an increasing fraction of the voltage drop is dissipated in transporting ions across the thin film rather than through the membrane. Therefore, the energy consumption per unit of ions transported increases significantly.

A point can be reached at which the ion concentration at the membrane surface is zero. This represents the maximum transport rate of ions through the thin film. The current through the membrane at this point is called the limiting current density, that is current per unit area of membrane (mA/cm2).

While various embodiments have been illustrated and described, it is to be understood that the invention is not so limited. Numerous modifications, changes, variations, substitutions and equivalents will occur to those skilled in the art without departing from the scope of the present invention as defined by the appended claims.

1. A portable replenishable scalable electrodialysis device comprising:
a salt water inlet for receiving salt water;
a fluid electrode inlet for receiving water comprising a conductive material;
a diluent water inlet for receiving diluent water;
a plurality of electrodialysis cells, each electrodialysis cell comprising:
a first conductive member extending a length of the electrodialysis cell, operatively coupled to a first current source having negative polarity;
a second conductive member extending the length of the electrodialysis cell, operatively coupled to a second current source having positive polarity;
a first removable membrane positioned adjacent the first conductive member, and configured to have a first polarity;
a second removable membrane positioned adjacent the second conductive member, and configured to have a second polarity opposite to the first polarity;
a third removable membrane positioned adjacent the first membrane, and configured to have the second polarity opposite to the first polarity;
a fourth removable membrane positioned adjacent the second membrane, and configured to have the first polarity;
a first channel positioned between the first membrane and the first conductive member, operatively coupled to the fluid electrode inlet such that water comprising a conductive material can be flowed through the first channel;
a second channel positioned between the second membrane and the second conductive member, operatively coupled to the fluid electrode inlet such that water comprising a conductive material can be flowed through the second channel;
a third channel positioned adjacent the first membrane, operatively coupled to the salt water inlet such that salt water can be flowed through the third channel;
a fourth channel positioned adjacent the second membrane, operatively coupled to the salt water inlet such that salt water can be flowed through the fourth channel; and
a fifth channel positioned between the third membrane and the fourth membrane, operatively coupled to the diluent water inlet such that diluent water can be flowed through the fifth channel.

2. A portable replenishable scalable electrodialysis device comprising:
a plurality of electrodialysis cells, each of said cells having a first end and a second end, each of said cells comprising a cell wall, each of said cells comprising removable end caps covering said respective cell first and second ends,
each of said cells having first and second conductive members extending a length of each of said electrodialysis cells, said first conductive member electrically connected to a first current source having negative polarity and said second conductive member electrically connected to a second current source having positive polarity,
each of said electrodialysis cells comprising first, second, third, and fourth membranes, said first membrane positioned adjacent said first conductive member, said second membrane positioned adjacent said second conductive member, said third membrane is positioned adjacent said first membrane, said fourth membrane is positioned adjacent said second membrane wherein said first and fourth membranes have a first polarity and said second and third membranes have a second polarity which is opposite of the first polarity of said first and fourth membranes and wherein said first, second, third and fourth membranes are removable from each of said electrodialysis cells,
each of said cells having first, second, third, fourth and fifth channels, said first channel positioned between said first membrane and said first conductive member, said second channel positioned between said second membrane and said second conductive member, said third channel positioned adjacent said first membrane, said fourth channel is positioned adjacent said second membrane, and said fifth channel is positioned between said third membrane and said fourth membrane,
wherein said electrodialysis device is connected to a source of water to be desalinated, a source of diluent water and a source of water comprising conductive material, wherein said water comprising said conductive material is flowed through said first channel and said second channel, and said water to be desalinated is flowed through said third and fourth channel and said diluent is flowed through said fifth channel.

3. The device of claim 2 additionally comprising first and second reservoirs, said first reservoir for containing the desalinated water and said second reservoir for containing a liquid salt waste.

4. The device of claim 2, wherein said first and second membranes comprise first and second edges, each of said membrane first and second edges comprise a sealing element.

5. The device of claim 2, wherein said third and fourth membranes comprises first and second edges, each of said membrane first and second edges comprise a sealing element.

6. The device of claim 2, additionally comprising a third reservoir for containing the water comprising the conductive material.

7. The device of claim 2 comprising six electrodialysis cells.

8. The device of claim 6, wherein said six electrodialysis cells are interconnected electrically.

9. The device of claim 6, wherein said six electrodialysis cells are interconnected allowing fluid flow from cell to cell.

10. The device of claim 2, wherein said first and second current sources are provided by a photovoltaic source of energy.

11. The device of claim 2, wherein said first and second current sources are provided by a source of energy derived from wind.

12. The device of claim 2, wherein said electrodialysis cell comprises a cylindrical tube comprising an interior wall.

13. The device of claim 11, wherein said electrodialysis cell comprises a first half and a second half joined along the length of said cell, said first half comprising an interior wall and said second half comprising an interior wall, said first conductive member affixed to said cell first half interior wall, said first membrane affixed to said cell first half interior wall adjacent said first conductive member forming said first channel, said second conductive member affixed to said cell second half interior wall adjacent, said second conductive member forming said second channel, said third membrane affixed to said first cell wall half adjacent said first membrane, said fourth membrane affixed to said second cell wall half adjacent said second membrane.

14. The device of claim 13, wherein said first half and said second half are joined together along their lengths forming a cylindrical tube with a contiguous outer surface.

15. The device of claim 4, wherein the sealing element comprises a cured adhesive.

16. The device of claim 4, wherein the sealing element comprises a polymeric rubber.

17. The device of claim 2, wherein the conductive member comprises copper.

18. The device of claim 2, wherein the conductive member comprises conductive graphite.

19. The device of claim 2, wherein the polarity of the first and third membrane is cationic.

20. The device of claim 2, wherein the polarity of the second and fourth membrane is anionic.
